(19) United States
(12) Patent Application Publication
(10) Pub. No.: US 2024/0333475 A1
(43) Pub. Date: Oct. 3, 2024

(54) SECRET MANAGEMENT IN CONTAINER-ORCHESTRAION SYSTEM

(71) Applicant: TELEFONAKTIEBOLAGET LM ERICSSON (PUBL), STOCKHOLM (SE)

(72) Inventors: Alessandro Da Canal, GENOVA (IT); Luciano Gemme, STAZZANO (IT); Andrea Fasce, GENOVA (IT)

(21) Appl. No.: 18/577,665

(22) PCT Filed: Jul. 8, 2021
(86) PCT No.: PCT/EP2021/068952

§ 371 Date: Jan. 8, 2024

(51) Int. Cl. H04L 9/08

(52) U.S. Cl. CPC H04L 9/0816

(57) ABSTRACT

Embodiments of the invention can relate to methods for operating a container group and/or a controller in a container-orchestration system for an effective management of a secret of the container-orchestration system. In one instance, the method comprises the steps of: creating the secret description for identifying one or more characteristics of the secret, creating the secret without data fields, instructing the controller to populate one or more of the data fields of the secret based on the secret description, accessing the secret. Further embodiments relate to a container group, a controller and a container-orchestration system.

### TECHNICAL FIELD

The present invention relates to a container-orchestration system and various methods for operating the container-orchestration system.

### BACKGROUND

FIG. 1 shows a container-orchestration system 1000 according to the prior art and know, for instance, from Kubernetes. The system 1000 comprises a plurality objects 1100, 1200, 1300.

In particular, the objects comprise container groups 1101-110N, each of which can comprise one or more containers 1110-111N. A container can be understood as a running image, where the image is a ready-to-run software package. In a Kubernetes implementation, the container groups 1100 can be implemented by Pods.

The objects further comprise secrets 1201-120N. The secrets are objects storing sensitive data in a secure way. They can be used to store sensitive data such as private keys, certificates, passwords, etc. The secrets can be mounted in the files system of a container group, so the data are readable as normal files. They cannot be altered or deleted by the container groups 1100, so that the data is reliably kept.

The objects further comprises at least one controller 1300, which can have higher privileges than the container groups 1100-110N, and in particular can modify the content of the secrets. This can be used, for instance, to update the value of passwords, or certificates, etc.

In some current commercial implementations of container-orchestration systems, for instance in Helm, the description of the objects is stored in a set of .yaml files in a chart folder, which are used by Helm to deploy the container groups 1100. In this respect, the chart folder and the. yaml files can be understood as being a configuration database 1400. This configuration requires also to declare, in the configuration database 1400, the secrets 1200, using default or initial values, that is, using some predetermined dummy values. For example, an initial password or a dummy certificate.

During runtime of the container groups 1100, these default values are replaced by the controller 1300 with the real ones. The controller 1300 can also keep them updated, for example in case of reissue of a certificate, a change of password, etc.

This implementation, however, suffers from a critical drawback during upgrade of the one or more container groups 1100. During an upgrade, the content of the data fields declared in a related secret 1200 is reset according to the predetermined dummy values defined in the configuration database 1400.

This is problematic since the real and/or updated values of the secrets 1200 are lost and replaced with the predetermined dummy values. Upon restart of the containers 1100, they will therefore access the predetermined dummy values instead of the correct secrets resulting in runtime errors and potentially security issues. To avoid this issue, currently, the controller 1300 needs to write again the correct values of the secrets 1200 after each upgrade. In case the secrets 1200 comprise certificates, this drawback is amplified by the fact that the certificate private keys are lost too and a TLS secure connection, based on the certificate, cannot be maintained

Moreover, particularly for certificates, there might be instances in which a new certificate is needed after upgrade, due to the loss of the previous one, so that the number of valid certificates in a PKI (Public Key Infrastructure) database for the same entity increases, which could lead to confusion on which certificate is the correct one.

For Cloud Native solution, this is a major drawback. Container groups 1100 are expected to be upgraded many times during their lifetime and every time a new certificate should be reissued for the entity. The increase of certificates for the same entity in PKI database could cause issues such as Out of Memory, usage of all the disk space available for PKI database, or even confusion on third parties. Moreover, during upgrade, the certificates are reissued, so the unavailability of the service, caused by awaiting the new certificate in the respective secret 1200, is greater than expected and could not be acceptable in various scenarios.

### SUMMARY

Accordingly, there is a need for techniques which allow the security and efficiency of multi-factor authentication to be improved. This need may be met by the features of the independent claims. Further aspects are described in the dependent claims.

An aspect can thus relate to a method for operating a container group for setting up a container-orchestration system, the container-orchestration system comprising the container group, a secret, a secret description and a controller, the method comprising the steps of: creating the secret description for identifying one or more characteristics of the secret, creating the secret without data fields, instructing the controller to populate one or more of the data fields of the secret based on the secret description, accessing the secret.

In some aspects the step of creating the secret can further comprise creating a mount point for the secret in the container group.

In some aspects the step of accessing the secret can comprise the steps of: checking whether the one or more of the data fields of the secret exist and have been populated and, accessing the one or more of the data fields of the secret which have been populated.

In some aspects the method can further comprise the step of instructing the controller to create the one or more data fields of the secret based on the secret description.

A further aspect can relate to a method for operating a controller for setting up a container-orchestration system, the container-orchestration system comprising a container group, a secret, a secret description and a controller, the method comprising the steps of: receiving instructions from the container group to populate one or more of the data fields of the secret, reading the secret description, retrieving first secret information based on the secret description, populating one or more of the data fields of the secret with the first secret information.

In some aspects the method can further comprise the step of creating the one or more data fields of the secret based on the secret description.

In some aspects the method can further comprise a step of checking the validity of the secret comprising the steps of: reading the secret description, retrieving second secret information based on the secret description, checking whether the one or more data fields of the secret correspond to the second secret information, and if the result of the checking step is negative, populating the one or more data fields of the secret with the second secret information.

A further aspect can relate to a method for operating a container group for upgrading a container-orchestration system, the container-orchestration system comprising the container group, a secret, a secret description and a controller, the method comprising the steps of: upgrading the container group without modifying one or more of the data fields of the secret, accessing the secret.

In some aspects the method can further comprise a step of instructing the controller to check one or more data fields of the secret based on the secret description,

In some aspects the can further comprise a step of creating the secret description for identifying one or more characteristics of the secret.

A further aspect can relate to a method for operating a controller for upgrading a container-orchestration system, the container-orchestration system comprising a container group, a secret, a secret description and the controller, the method comprising the steps of: receiving instructions from the container group to check the one or more data fields of the secret, reading the secret description, retrieving first secret information based on the secret description, checking the one or more data fields of the secret with respect to the first secret information.

In some aspects the method can further comprise, in case of a negative result of the checking step, a step of populating the one or more of the data fields of the secret with the first secret information.

In some aspects the method can further comprise a step of creating one or more data fields of the secret based on the secret description.

In some aspects the retrieving step can comprise retrieving first secret information from a server external to the container-orchestration system.

A further aspect can relate to a method for operating a container group in a container-orchestration system, the container-orchestration system comprising the container group, a secret, a secret description and a controller, the method comprising the steps of: creating the secret description for identifying one or more characteristics of the secret, creating the secret without data fields, instructing the controller to populate one or more data fields of the secret based on the secret description, upgrading the container group without modifying one or more of the data fields of the secret.

A further aspect can relate to method for operating a controller in a container-orchestration system, the container-orchestration system comprising a container group, a secret, a secret description and the controller, the method comprising the steps of: reading the secret description, retrieving first secret information based on the secret description, populating one or more of the data fields of the secret with the first secret information, after upgrading of the container group, reading the secret description, retrieving first secret information based on the secret description, checking the one or more data fields of the secret with respect to the first secret information.

A further aspect can relate to a method for operating a container-orchestration system the container-orchestration system comprising a container group, a secret, a secret description and a controller, the method comprising the steps of: creating the secret description for identifying one or more characteristics of the secret, creating the secret without data fields, populating one or more data fields of the secret based on the secret description.

In some aspect the method can further comprise the step of upgrading the container group without modifying one or more of the data fields of the secret.

In some aspects the secret description can comprise a XML file identifying the one or more characteristics of the one or more data fields of the secret.

In some aspects the one or more data fields of the secret can comprise certificates for establishing a TLS connection.

In some aspects the secret can further comprise one or more of: a name of the secret, an object type, one or more service fields, indicating a name of the container group having ownership of the secret.

In some aspects the container-orchestration system can comprise Kubernetes, and/or the container group can comprise a Pod.

A further aspect can relate to a container-orchestration system comprising one or more objects, the one or more objects comprising: a container group, a secret, a secret description, and a controller, wherein the secret description can be an object separate from the secret and is configured for identifying one or more characteristics of one or more data fields of the secret.

A further aspect can relate to a container group for use in a container-orchestration system, the container-orchestration system comprising the container group, a secret, a secret description and a controller, the container group comprising: a processing unit, a memory, the memory comprising instructions configured to cause the processing unit to carry out the method according to any of the previous aspects.

A further aspect can relate to a controller for use in a container-orchestration system, the container-orchestration system comprising the container group, a secret, a secret description and a controller, the controller comprising: a processing unit, a memory, the memory comprising instructions configured to cause the processing unit to carry out the method according to any of the previous aspects.

A further aspect can relate to a container-orchestration system comprising the container group according to any previous aspect and/or the controller according to any previous aspect.

A further aspect can relate to a container group comprising a plurality of modules, wherein each module is configured for implementing one of the steps above.

A further aspect can relate to a controller comprising a plurality of modules, wherein each module is configured for implementing one of the steps above.

A further aspect can relate to a container-orchestration system comprising a plurality of modules, wherein each module is configured for implementing one of the steps above.

### DESCRIPTION OF DRAWINGS

Various features of embodiments will become more apparent when read in conjunction with the accompanying drawings. In these drawings:

FIG. 1 schematically illustrates a container-orchestration system 1000 according to the prior art;

FIG. 2 schematically illustrates a method 2000 for setting-up a container-orchestration system 4000;

FIG. 3 schematically illustrates a method 3000 for upgrading a container-orchestration system 4000;

FIG. 4 schematically illustrates a container-orchestration system 4000.

FIG. 5 schematically illustrates a method for operating a container group 4100 for setting-up a container-orchestration system 4000;

FIG. 6 schematically illustrates a method for operating a controller 4300 for setting-up a container-orchestration system 4000;

FIG. 7 schematically illustrates a method for operating a container group 4100 for upgrading a container-orchestration system 4000;

FIG. 8 schematically illustrates a method for operating a controller 4300 for upgrading a container-orchestration system 4000;

FIG. 9 schematically illustrates a method for operating a container group 4100 in a container-orchestration system 4000;

FIG. 10 schematically illustrates a method for operating a controller 4300 in a container-orchestration system 4000;

FIG. 11 schematically illustrates a method for operating a container-orchestration system 4000;

FIG. 12 schematically illustrates a container group 4100;

FIG. 13 schematically illustrates a controller 4300;

FIG. 14 schematically illustrates modules of a container group 4100;

FIG. 15 schematically illustrates modules of a controller 4300;

FIG. 16 schematically illustrates modules of a container group 4100;

FIG. 17 schematically illustrates modules of a controller 4300;

FIG. 18 schematically illustrates modules of a container group 4100;

FIG. 19 schematically illustrates modules of a controller 4300;

FIG. 20 schematically illustrates modules of a container-orchestration system 4000.

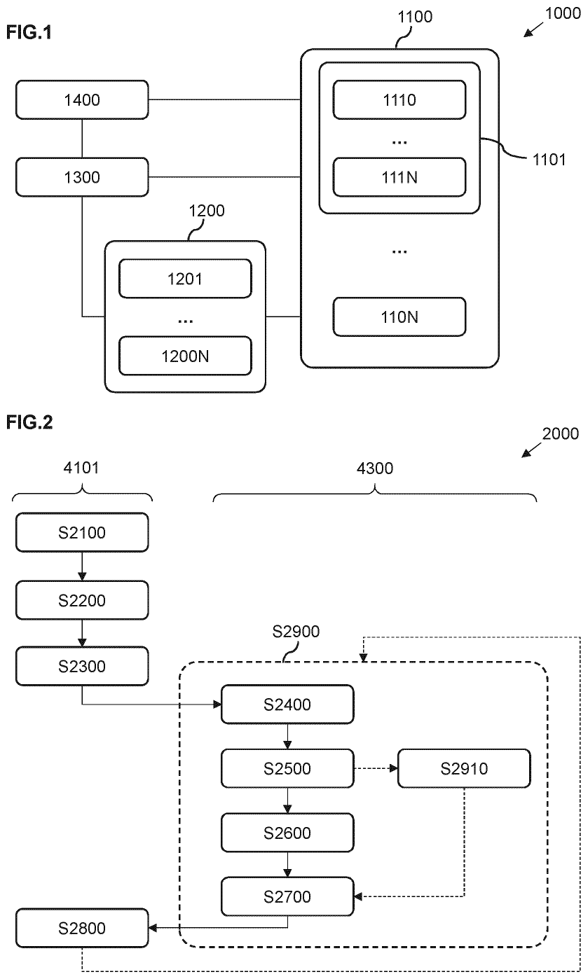

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

Moreover, the description is provided with respect to a single container group 1100 and a single secret 1200. If will however be clear that a similar approach can be applied a plurality of times, in parallel and/or in series, for a plurality of container groups 1100 and/or a plurality of secrets 1200.

FIG. 2 shows a method 2000 for operating a container group 4100 for setting up a container-orchestration system 4000, such as the one illustrated in FIG. 4. In particular, the container-orchestration system 4000 comprises a plurality of objects among which at least the container group 4100, a secret 1200, a secret description 4400 and a controller 4300.

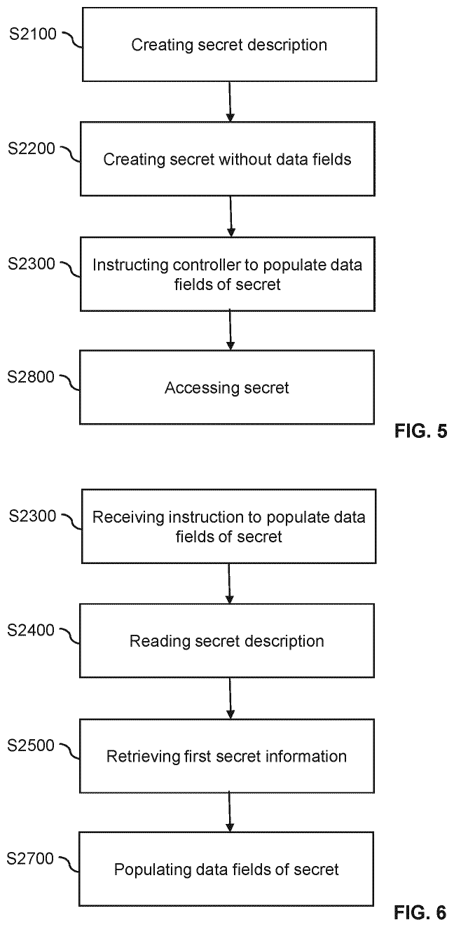

The method 2000 comprises a plurality of steps, some of which can be executed by the container group 4100 and some of which can be executed by the controller 4300, for instance in the manner indicated in FIG. 2. It will be clear that it is not necessary to execute all illustrated steps for implementing the invention. For instance, FIG. 5 illustrates steps from FIG. 2 which can be executed when operating a container group 4100 for setting up a container-orchestration system 4000. Similarly, FIG. 6 illustrates steps from FIG. 2 which can be executed when operating a controller 4300 for setting up a container-orchestration system 4000.

The method for operating a container group 4100 comprises a step S2100 of creating the secret description 4400 for identifying one or more characteristics of the secret 1200. In general, the secret description can be any information which allows a secret to be identified. For instance, if a certificate for establishing a TLS connection with a given server is needed as secret, the secret description might comprise all information needed for identifying the certificate, that is, the one or more characteristics of the secret 1200, such as the description of the server to which connection is to be established and an indication that a certificate for TLS connection is needed. In general then, the secret description is not the secret itself but a collection of information which can be used to unambiguously identify the secret at a secret provider. It will be clear that, in case a plurality of secret information is to be stored into a secret, intended as the object, the secret description can comprise a plurality of one or more characteristics, or groups of characteristics, each one for identifying the respective secret information. That is, for instance, if the secret 1200 is configured to comprise a plurality of TLS certificates, the secret description 4400 can provide a plurality of one or more characteristics, or groups of characteristics allowing identification of the plurality of TLS certificates.

The method for operating the container group 4100 further comprises a step S2200 of creating the secret 1200 without data fields. That is, the secret 1200 as an object can be created, however its content, namely the one or more data fields, for instance the value of TLS certificates, private key, etc. are not present. This allows the secret 1200 as an object to be mounted in the container-orchestration system 4000 without necessarily initializing the data fields of the secret 1200 to a predetermined value, as is done in the prior art. This ensures that incorrect operation of the container group 4100, which might try to use the secret 1200 when the values of the data fields are still the predetermined ones can be avoided. In particular, if the container group 4100 tries to access the secret, it will find the various data fields not to be present, so that the risk of operating based on incorrect data can be avoided. Moreover, as will become clearer from the following description, this implementation also allows an improved procedure for upgrading the container group 4100.

The method for operating the container group 4100 further comprises a step S2300 of instructing the controller 4300 to populate S2700 one or more of the data fields of the secret 1200 based on the secret description 4400. For instance, based on the one or more characteristics of the secret 1200 it can be determined which specific certificate a data field is to be populated with. As an example, the one or more characteristic in the secret description 4400 might indicate that a certificate for a certain type of secure connection with a given server is needed, so that the controller 4300 can identify the given server and the given type of certificate needed for the connection.

In some embodiments, the instructing step can further comprise instructing the controller 4300 to create S2600 the one or more data fields of the secret 1200, based on the secret description 4400. For instance, based on the one or more characteristics of the secret 1200 it can be determined how many data fields are to be created, and/or which type of data fields are to be created.

Alternatively, or in addition, the creating step S2600 might comprise the steps of checking whether the one or more data fields exist, and creating them if the result of the check is negative. This might useful in case, for instance, when the one or more data fields have been created by another entity, or object, in the container-orchestration system 4000.

Although the creating step S2600 and the populating step S2700 have been described separately, it is understood that in some embodiments they might be implemented in a single step, by creating the one or more data fields directly with the secret information retrieved by the controller 4300.

This method therefore allows the data fields to be created and the values of the data fields to be populated, after the secret 1200 has been created and, in particular, based on the information contained in the secret description 4400. In this manner it can be advantageously ensured that when the one or more data fields in the secret 1200 comprise a value, this is not a standard predetermined value simply used as a placeholder, but is instead the correct value of the secret.

The method for operating the container group 4100 further comprises a step of accessing S2800 the secret 1200. That is, as the one or more data fields of the secret 1200 now comprise correct secret information, the container group 4100, and in particular one of the containers in the container group 4100, can access the secret information in the secret 1200. If the secret information, namely the one or more data fields of the secret 1200, is present, the or one of the containers in the container group 4100 can reliably consider that the secret information is valid.

In other words, by allowing the container group 4100 to create the secret description 4400, the one or more containers in the container group 4100 can identify the amount and type of data fields, and/or the secret information which is needed for its operation, through corresponding identification information, that it, the one or more characteristics. This identification information can be stored by the container group 4100 in the secret description 4400 and later retrieved by the controller 4300, which can then proceed to create the one or more data fields and/or retrieve the secret information, for instance from a secret database DB, such as a server comprising TLS certificates, public/private keys, or other types of secret information. The controller 4300 can identify the needed secret information based on the identification information, obtain the needed secret information from the database DB, and store it in one or more fields of the secret 1200. In this manner, the data fields of the secret 1200 can be later accessed by the one or more containers in the container group 4100. Meanwhile, since the secret 1200 is created as an object, it can be correctly mounted in the container group 4100, and/or more generally in the container-orchestration system 4000, even though the data fields of the secret 1200 are not present.

The database DB has been described above and illustrated as a component separate from the controller 1300, and possibly external to the container-orchestration system 4000. It will however be clear that the invention is not limited thereto and that the database DB might be a part of the container-orchestration system 4000, for instance in form of a further object of the container-orchestration system 4000, and it might even be incorporated into the controller 1300.

In some embodiments, the step S2200 of creating the secret 1200 can further comprise creating a mount point for the secret 1200 in the container group 4100. That is, the secret 1200 can be mounted in the one or more containers 1110-111N even though the data fields of the secret 1200 have not been created yet. This allows the configuration of the container 1100 to be completed, independently of the presence of the secret information in the one or more data fields.

In some embodiments, the step S2800 of accessing the secret 1200 can comprise a step of checking whether the one or more of the data fields of the secret 1200 exist and have been populated and a step of accessing the one or more of the data fields of the secret 1200 which have been populated. Thanks to this approach, only those data fields which have been populated can be accessed by the containers in the container group, so that it can be ensured that unwanted operation, due to the lack of the values in the data fields of the secret 1200, can be avoided.

As visible in FIGS. 2 and 6, a method for operating a controller 4300 for setting up the container-orchestration system 4000 comprises a steps S2300 of receiving instructions from the container group 4100 to populate one or more of the data fields of the secret 1200.

The method for operating the controller 4300 further comprises a step of reading S2400 the secret description 4400. It will be clear that, in some embodiments, the controller 4300 might be instructed to read only part of the secret description 4400. By reading the secret description, the controller 4300 can retrieve all necessary information for retrieving the corresponding secrets, for instance from the database DB.

The method for operating the controller 4300 further comprises a step of retrieving S2500 first secret information based on the secret description 4400. The first secret information is not intended as being first in a list, or temporally, the adjective first here is used to distinguish the secret information from one or more potentially different secret information described later in the description.

The method for operating the controller 4300 further comprises a step of populating S2700 one or more of the data fields of the secret 1200 with the first secret information. Thanks to this approach, the secret information can be made available to the one or more container in the container group 1100, based on the specification provided by the container group 1100 in the secret description 4400.

In some embodiments, the method for operating the controller 4300 can further comprise a step of creating S2600 the one or more data fields of the secret 1200 based on the secret description 4400.

The above description provides an indication of how the container-orchestration system 4000 can be set-up. After this initial set-up, it is often the case that the values stored in the secret, and in particular the content of the one or more data fields, needs updating. For instance, if the one or more data fields comprises a TLS certificate or a private key it might be the case that the certificate or the key has expired or has been withdrawn, and needs to be replaced by a new one. Alternatively, or in addition, it might be the case that the one or more container needs a new secret value, which can be identified by a corresponding change in the secret description 4400.

As described, the container group 1100 is not allowed to access the secret 1200 for writing into it, so that it cannot update the content of the data fields itself. In order to provide such update, in some embodiments, the method for operating the controller 4300 can therefore further comprise a step S2900 of checking the validity of the secret 1200, as illustrated in FIG. 2. As visible in FIG. 2, the elements related to step S2900 are indicated with a dashed line, to distinguish the operation of those elements when part of step S2900 and when not.

In particular, the step S2900 can be preferably be executed after step S2800, or in general after step S2700 and comprises a step S2400 of reading the secret description 4400. This instance of step S2400 operates in the same manner as previously described.

The step S2900 can further comprise a step S2500 of retrieving second secret information based on the secret description 4400. This instance of step S2500 operates in the same manner as previously described, except that the content of the second secret information might differ from the content of the first secret information. This might be because, for instance, the secret description 4400 has changed and/or because the value of the secret information has been changed at the database DB.

The step S2900 can further comprise a step S2910 of checking whether the one or more data fields of the secret 1200 correspond to the second secret information, and if the result of the checking step S2910 is negative, a step S2700 of populating the data fields of the secret 1200 with the second secret information.

In this manner, if it is determined that the secret information identified by the secret description 4400 has changed, for any reason, the step S2900 can ensure that the updated secret information is correctly stored in the secret 1200. In some embodiments, the step S2900 can thus be executed regularly, for instance with a predetermined frequency, to ensure that the content of the secret is up to date.

The embodiments described so far allow to set-up and update the secret, in a container-orchestration system 4000. It is common, in such systems, that the one or more containers included in the container group 4100 need to be upgraded, for instance because of a new release of software, etc. In the prior art, the upgrading of the container group 4100 would have also resulted in the generation of a new secret 1200, with the data fields being populated again with the predetermined value. This is not desirable since it might lead to a malfunction of the one or more containers in the container group 4100, which might rely on the content of the secret 1200 as being correct. Moreover, if the content of the secret needs to be populated again, the prior art systems would issue a request for a new secret to be generated by the database DB, due to the loss of the previous one, which would increase the number of secrets to be managed by the container-orchestration system 4000. As will become clear from the following embodiments, in the invention those problems can be avoided.

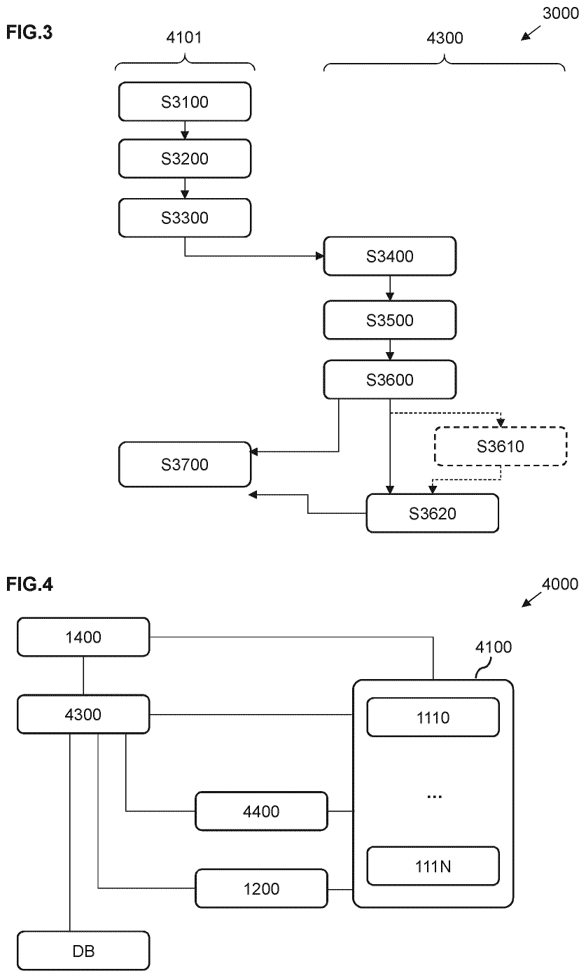

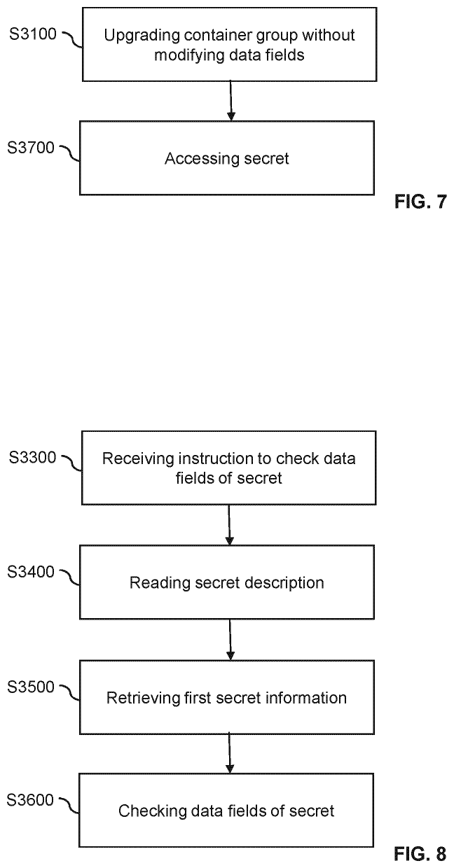

In particular, as visible in FIGS. 3 and 7, a method for operating a container group 4100 for upgrading the container-orchestration system 4000 comprises a step S3100 of upgrading the container group 4100. The upgrading can comprise upgrading one or more of the containers 1110-111N in the container group 1100. Various manners are known for performing the upgrading, depending on the specific implementation of the container-orchestration system 4000. Contrary to the prior art, the step S3100 is carried out without modifying one or more of the data fields of the secret 1200, and preferably without modifying any of the existing one or more data fields of the secret 1200. That is, contrary to the prior art, during the upgrading the value of the one or more data fields is not overwritten, for instance with a predetermined value.

In other words, the secret 1200 can be created without data fields, for instance because it is defined so in a configuration file of the container-orchestration system 4000, such as for instance the “chart” folder in a Helm implementation. When the upgrade is performed, this configuration file can be used for upgrading the secret 1200, as an object. However, since the configuration file does not comprise the one or more data fields, the data fields are not overwritten during the upgrade.

The method for operating the container group 4100 can further comprise a step S3300 of instructing the controller 4300 to check the data fields of the secret 1200 based on the secret description 4400. Thanks to this step, the controller can be made aware if a change in the value of the secret is needed. Further operation of the controller 4300 can then result in the secret 1200 being populated, as previously described.

The method for operating the container group 4100 further comprises a step of accessing S3700 the secret 1200. Step S3700 is similar to the previously described step S2800.

In some embodiments, the method for operating the container group 4100 can further comprise step S3200 of creating the secret description 4400 for identifying one or more characteristics of the secret 1200. The step S3200 can generally operate as the previously described step S2200. It will be noted that this step might be optional, and the method could maintain the secret description 4400 previously created at the setting-up of the container-orchestration system 4000. For instance, it might be determined that the upgrade does not require the secret description 4400 to be changed, in which case the previously created secret description 4400 can be maintained. Thanks to this method it is possible to take into account a secret description 4400 which might be changed, due to the upgrade.

Thanks to this upgrading method, it can be ensured that the secret 1200 is maintained during the upgrade, so that it can be avoided that a new secret is created with predetermined values at each upgrade, and/or that a plurality of new secrets must be generated every time an upgrade is carried out. This also ensures a quick turnaround during upgrade, as the container group 4100 can immediately access the secret 1200 after the upgrade.

At the same time, since the secret description 4400 can be changed during the upgrade, the method provides flexibility to the container-orchestration system 4000. In fact, any change in the secret description 4400 can result in a corresponding change of the secret 1200, through steps caused by the step S3300, as will be discussed in the following, and/or through the execution of step S2900, as previously described.

As visible in FIGS. 3 and 8, a method for operating a controller 4300 for upgrading the container-orchestration system 4000 comprises a step S3300 of receiving instructions from the container group 4100 to check the data fields of the secret 1200.

The method for operating the controller 4300 further comprises a step S3400 of reading the secret description 4400, similar to previously described step S2400 and a step S3500 of retrieving first secret information based on the secret description 4400, similar to previously described step S2500. In this manner, the controller 4300 can retrieve the first secret information corresponding to the identification information provided by the secret description 4400.

The method for operating the controller 4300 further comprises a step S3600 of checking the data fields of the secret 1200 with respect to the first secret information. That is, it can be checked whether the one or more data fields correspond to the first secret information. If they do, it can be concluded that the secret information in the secret 1200 is still correct. In this manner, the method allows maintenance of the secret 1200 in most cases, where the upgrade of the container 1100 did not result in any changes to the secret. This saves processing power in that the secret does not need to be re-written at each upgrade, and it reduces down-time, since the upgraded container 1100 can immediately access the content of the secret 1200 after upgrade.

If, on the other hand, the result of the checking step S3600 is negative for one or more data fields, the method for operating the controller 4300 can further comprise a step S3620 of populating the one or more of the data fields of the secret 1200, preferably the one or more data fields for which the result of the checking step S3600 was negative, with the first secret information. In this manner, should any change in the content of the secret 1200 be derived from the upgrade, for instance through a new secret description 4400, or from an update of the secret information at the same time of the upgrade of the container 1100, the method allows to quickly determine that the content of the secret is no longer correct, and update it accordingly.

In some embodiments, the method for operating the controller 4300 can further comprise a step S3610 of creating one or more data fields of the secret 1200. This might become needed, for instance, when the new secret description 4400 indicates one or more data fields which were previously not present. In some embodiments, therefore, the step S3610 can comprise a step of checking whether one or more data fields are present in the new secret description 4400 and not in the secret 1200, and creating the missing one or more data fields. In embodiments in which the step S3610 is present, the populating step S3620 might thus be configured to further populate the one or more data fields created at step S3610. In some embodiments, in particular when one or more new data fields is created in this manner, the data fields which are not modified at step S3100 are intended to be the one or more data field existing prior to step S3100.

In some embodiments, step S2500 and/or S3500 can comprise retrieving the first secret information from a server external to the container-orchestration system 4000, such as the database DB. The server can be, for instance, a serve storing any of public keys, private key, certificates, and in particular TLS certificates. It will however be clear that the database DB can also be integrated into the container-orchestration system 4000.

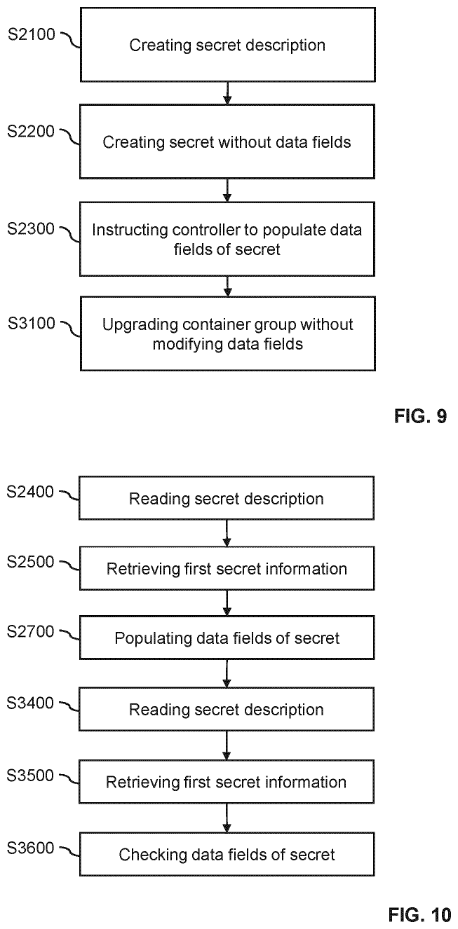

As illustrated in FIGS. 2, 3 and 9, a method for operating a container group 4100 can thus comprise the step S2100 of creating the secret description 4400 for identifying one or more characteristics of the secret 1200, the step S2200 of creating the secret 1200 without data fields, the step S2300 of instructing the controller 4300 to populate S2700 one or more data fields of the secret 1200 based on the secret description 4400, and the step S3100 of upgrading the container group 4100 without modifying one or more of the data fields of the secret 1200.

Moreover, as illustrated in FIGS. 2, 3 and 10, a method for operating a controller 4300 can thus comprise the step S2400 of reading the secret description 4400, the step S2500 of retrieving first secret information based on the secret description 4400, the step S2700 of populating one or more of the data fields of the secret 1200 with the first secret information. After upgrading of the container group 4100, the method can further comprise the step S3400 of reading the secret description 4400, the step S3500 of retrieving first secret information based on the secret description 4400, and the step S3600 of checking the one or more data fields of the secret 1200 with respect to the first secret information.

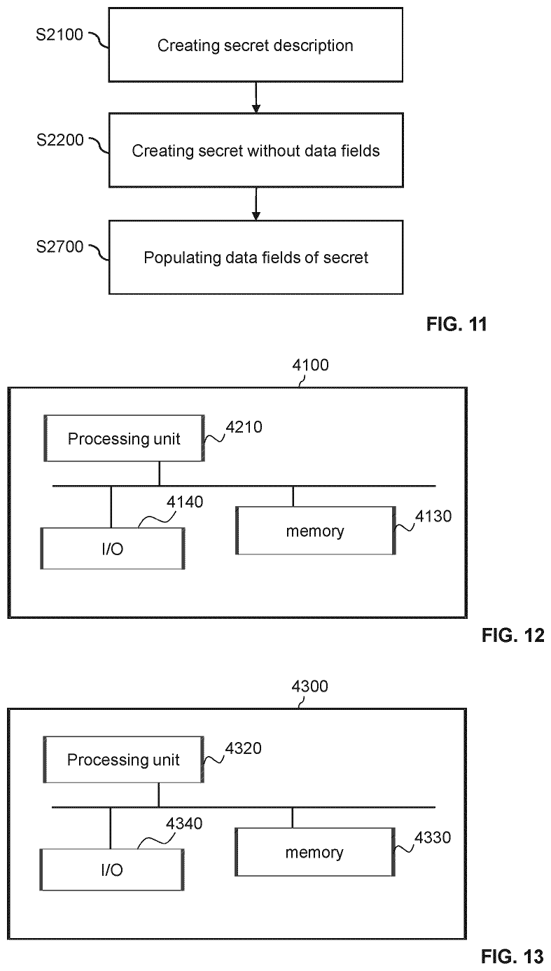

Furthermore, as illustrated in FIGS. 2, 3 and 11, a method for operating a container-orchestration system 4000 can comprise the step S2100 of creating the secret description 4400 for identifying one or more characteristics of the secret 1200, the step S2200 of creating the secret 1200 without data fields, and the step S2700 of populating one or more data fields of the secret 1200 based on the secret description 4400. In some embodiments, the method can further comprise the step S3100 of upgrading the container group 4100 without modifying one or more of the data fields of the secret 1200. It is in particular noted that any of those steps, and more generally any step described, might be executed by any entity in the container-orchestration system 4000. While those entity might be any of those which have been described, it will be clear that further entities known to the skilled person might be implemented too. Thus, embodiments will be possible in which, for instance, the secret description 4400 is created by an entity other than the container group 4100, for instance by a high-level controller of the container-orchestration system 4000, etc.

In some embodiments, the secret description 4400 can comprise a XML file identifying the one or more characteristics of the one or more data fields of the secret 1200. That is, the identification information for the data fields of the secret 1200 can be expressed with an XML file.

In some embodiments, the one or more data fields of the secret 1200 can comprise certificates for establishing a TLS connection. In this manner it is possible to set-up and upgrade the container-orchestration system 4000 without repeatedly requesting issues of new TLS certificates due to the old ones being deleted when the secret 1200 is created with predetermined values, as in the prior art.

While the description above has mostly discussed the data fields of the secret 1200, that is the secret information contained in the secret 1200, the secret 1200 can further comprises one or more of a name of the secret 1200, an object type, one or more service fields, indicating a name of the container group 4100 having ownership of the secret 1200.

Although the invention can be applied to any container-orchestration system 4000, it has been found by the inventors that it is particularly suitable to an implementation in which the container-orchestration system 4000 comprises Kubernetes, or is based on Kubernetes, or corresponds to Kubernetes and/or wherein the container group 4100 comprises a Pod, or corresponds to a Pod. Even more specifically, it has been found that the invention can be advantageously applied to a container-orchestration system 4000 implemented by Helm and based on Kubernetes.

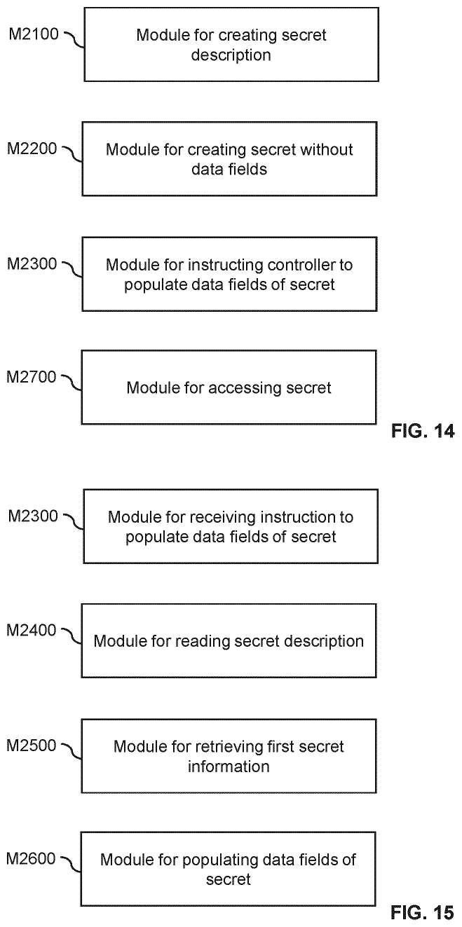

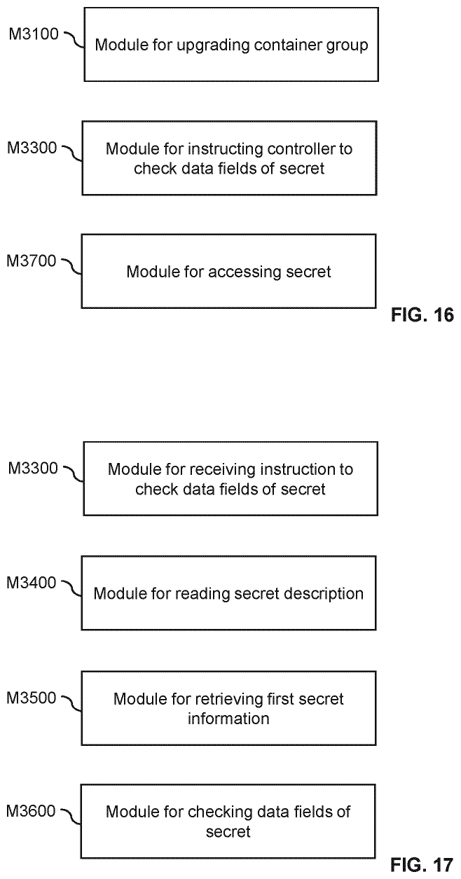

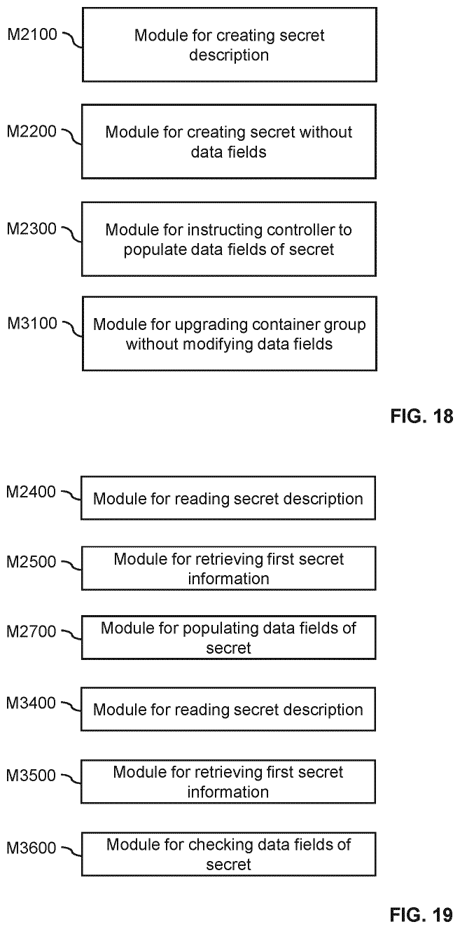

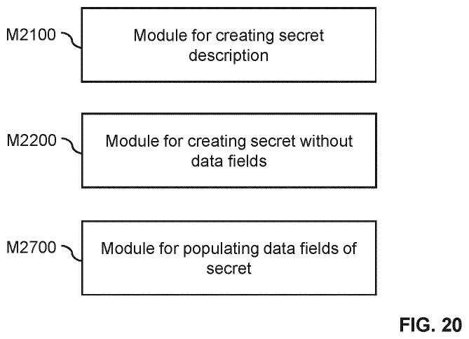

While the embodiments above have been expressed in terms of method steps, it is clear that the invention can also be implemented as a device. In particular, as visible in FIGS. 14-17, the previously described method steps can be implemented by a plurality of corresponding modules. Thus, a container group 4100 can comprise modules M2100, M2200, M2300, and M2700, as visible in FIG. 14, respectively implementing the functionality of steps S2100, S2200, S2300, and S2800 previously discussed. Additionally, a container group 4100 can comprise modules M3100, M3300, and M3700, as visible in FIG. 16, respectively implementing the functionality of steps S3100, S3300, and S3700 previously discussed. Similarly, a controller 4300 can comprise modules M2300, M2400, M2500, and M2600, as visible in FIG. 15, respectively implementing the functionality of steps S2300, S2400, S2500, and S2700 previously discussed. Additionally, a controller 4300 can comprise modules M3300, M3400, M3500, and M3600, as visible in FIG. 17, respectively implementing the functionality of steps S3300, S3400, S3500, and S3600 previously discussed. These modules may comprise any combination of software and/or hardware.

A computer program may be configured to, when run on a computer, perform one or more of any of the steps described as being carried out by the container group 4100. The computer program may be comprised within a computer program product. Additionally a computer program may be configured to, when run on a computer, perform one or more of any of the steps described as being carried out by the controller 4300. The computer program may be comprised within a computer program product.

Additionally, a container-orchestration system 4000, as visible in FIG. 4, can comprise one or more objects, the one or more objects comprising a container group 4100, a secret 1200, a secret description 4400, and a controller 4300. In particular, the secret description 4400 can be an object separate from the secret 1200 and can be configured for identifying one or more characteristics of one or more data fields of the secret 1200, as previously described. The one or more objects may comprise any combination of software and/or hardware.

Moreover, as visible in FIG. 12, a container group 4100 for use in a container-orchestration system 4000, wherein the container-orchestration system 4000 comprises at least the container group 4100, the secret 1200, the secret description 4400 and the controller 4300, can comprise a processing unit 4120 and a memory 4130. In some embodiments the container group 4100 can further comprise and input/output unit 4140. The memory 4130 preferably comprises instructions configured to cause the processing unit 4120 to carry out one or more of any of the steps previously described as being carried out by the container group 4100.

Similarly, as visible in FIG. 13, a controller 4300 for use in a container-orchestration system 4000, wherein the container-orchestration system 4000 comprises at least the container group 4100, the secret 1200, the secret description 4400 and the controller 4300, can comprise a processing unit 4320 and a memory 4330. In some embodiments the controller 4300 can further comprise and input/output unit 4340. The memory 4330 preferably comprises instructions configured to cause the processing unit 4320 to carry out one or more of any of the steps previously described as being carried out by the controller 4300.

It has therefore been described how the set-up and/or upgrade of secrets can be based on declaring secrets 1200, without populating data fields in them. For instance, in the context of a Helm and/or Kubernetes environment, the secrets 1200 can be declared in the chart folder used by Helm to deploy the containers group 4100, or services. It has moreover been discussed how mount points can be linked to secrets 1200 are can be declared in deployment of a service, or a container group 4100, but without items inside, in particular without the data fields. It has been further described how data fields of the secrets 1200, for instance certificates such as TLS certificates, can be populated by the controller 4300, acting as a certificate distributor. In particular, right after the creation of the secrets 1200, the mount point inside the service, or controller, can be seen as an empty folder. When the controller 4300 injects the secret data in the secret 1200, new files can be created in it, containing the secret information, that is, the data fields described above. Since the data fields are not present in the service chart, when the container group 4100 is upgraded the upgrade does not operate on them and their values can be preserved. In this manner, the content of the secrets 1200 can be maintained during upgrade and the services, or container groups 4100, can continue to access their secrets during upgrade time. At any time during execution, the service, or container group 4100, can wait if it does not find the files corresponding to the data fields. This avoids incorrect operation of the container 4100, which can be sure that if the files are present it means the data has been populated by the controller 4300 and can be reliably used by the container 4100.

In some embodiments, in the context of an implementation with Helm, it is possible for any of the above steps, and in particular for steps S2100 and/or S2200, to be executed by Helm upon deploying a service, that is, upon deploying one container group 4100. Alternatively, or in addition, in the context of an implementation with Helm, the step S2300 and/or S3300 can be implemented with a REST command.

Although the invention has been explained and illustrated with reference to a plurality of embodiments each containing a number of features, it will be clear that one or more features from one or more embodiment can be combined with one or more features from one or more other embodiment.

1. A method for operating a container group for setting up a container-orchestration system, the container-orchestration system comprising the container group, a secret, a secret description and a controller, the method comprising the steps of:
creating the secret description for identifying one or more characteristics of the secret,
creating the secret without data fields,
instructing the controller to populate one or more data fields of the secret based on the secret description,
accessing the secret.

2. The method according to claim 1, wherein the step of creating the secret further comprises creating a mount point for the secret in the container group.

3. The method according to claim 1, wherein the step of accessing the secret comprises the steps of:
checking whether the one or more of the data fields of the secret exist and have been populated and,
accessing the one or more of the data fields of the secret which have been populated.

4. The method according to claim 1, wherein the instructing step further comprises:
instructing the controller to create the one or more data fields of the secret based on the secret description.

5. A method for operating a controller for setting up a container-orchestration system, the container-orchestration system comprising a container group, a secret, a secret description and the controller, the method comprising the steps of:
receiving instructions from the container group to populate one or more data fields of the secret,
reading the secret description,
retrieving first secret information based on the secret description,
populating one or more of the data fields of the secret with the first secret information.

6. The method according to claim 5, further comprising the step of:
creating the one or more data fields of the secret based on the secret description.

7. The method according to claim 5, further comprising a step checking the validity of the secret comprising the steps of:
reading the secret description,
retrieving second secret information based on the secret description,
checking whether the one or more data fields of the secret correspond to the second secret information, and
if the result of the checking step is negative, populating the one or more data fields of the secret with the second secret information.

8. A method for operating a container group for upgrading a container-orchestration system, the container-orchestration system comprising the container group, a secret comprising one or more data fields, a secret description and a controller, the method comprising the steps of:
upgrading the container group without modifying one or more of the data fields of the secret,
accessing the secret.

9. The method according to claim 8 further comprising a step of
instructing the controller to check one or more data fields of the secret based on the secret description.

10. The method according to claim 8 further comprising a step of creating the secret description for identifying one or more characteristics of the secret.

11. A method for operating a controller for upgrading a container-orchestration system, the container-orchestration system comprising a container group, a secret comprising one or more data fields, a secret description and the controller, the method comprising the steps of:
receiving instructions from the container group to check the one or more data fields of the secret,
reading the secret description,
retrieving first secret information based on the secret description,
checking the one or more data fields of the secret with respect to the first secret information.

12. The method according to claim 11 further comprising, in case of a negative result of the checking step, a step of populating the one or more of the data fields of the secret with the first secret information.

13. The method according to claim 11 further comprising a step of creating one or more data fields of the secret based on the secret description.

14. The method according to claim 5, wherein the retrieving step comprises retrieving first secret information from a server external to the container-orchestration system.

15-26. (canceled)

27. The method according to claim 11, wherein the retrieving step comprises retrieving first secret information from a server external to the container-orchestration system.
